(19) United States
(12) Patent Application Publication
(10) Pub. No.: US 2021/0303437 A1
(43) Pub. Date: Sep. 30, 2021

(54) ANALYSING REACTIVE USER DATA

(71) Applicant: INTERNATIONAL BUSINESS MACHINES CORPORATION, Armonk, NY (US)

(72) Inventors: Venkata Vara Prasad Karri, Visakhapatnam (IN); Saraswathi Sailaja Perumalla, Visakhapatnam (IN); Kamal Kiran Trood Yamala, Visakhapatnam (IN); Sampath Kumar Pulupula Venkata, Visakhapatnam (IN)

(21) Appl. No.: 16/827,802

(22) Filed: Mar. 24, 2020

(51) Int. Cl. G06F 11/34; G06F 3/01; G06K 9/00; G06F 16/9035

(52) U.S. Cl. CPC G06F 11/3438; G06F 16/9035; G06K 9/00302; G06F 3/011

(57) ABSTRACT

A method, a structure, and a computer system for analysing user reactive data is disclosed herein. Exemplary embodiments may include detecting interaction with data by a user and extracting one or more user features from the user. Exemplary embodiments may further include extracting one or more data features from the data and identifying one or more data features interacted with by the user of the one or more data features. Moreover, exemplary embodiments may further include matching the one or more user features with the one or more data features interacted with by the user, and determining an interest level in the one or more data features interacted with by the user based on the matched one or more user features.

### BACKGROUND

The exemplary embodiments relate generally to data analysis, and more particularly to capturing and analysing reactive user data.

Users may react differently in response to data consumption. Reactions may include interest, laughter, sadness, or even concern, and these reactions may be exhibited by a user in their language and body language.

### SUMMARY

The exemplary embodiments disclose a method, a structure, and a computer system for analysing reactive user data. Exemplary embodiments may include detecting interaction with data by a user and extracting one or more user features from the user. Exemplary embodiments may further include extracting one or more data features from the data and identifying one or more data features interacted with by the user of the one or more data features. Moreover, exemplary embodiments may further include matching the one or more user features with the one or more data features interacted with by the user, and determining an interest level in the one or more data features interacted with by the user based on the matched one or more user features.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary schematic diagram of a reactive data analysis system 100, in accordance with the exemplary embodiments.

FIG. 2 depicts an exemplary flowchart 200 illustrating the operations of a reactive data analyser 142 of the reactive data analysing system 100, in accordance with the exemplary embodiments.

FIG. 3 depicts an exemplary block diagram depicting the hardware components of the reactive data analysis system 100 of FIG. 1, in accordance with the exemplary embodiments.

FIG. 4 depicts a cloud computing environment, in accordance with the exemplary embodiments.

FIG. 5 depicts abstraction model layers, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

Users may react differently in response to data consumption. Reactions may include interest, laughter, sadness, or even concern, and these reactions may be exhibited by a user in their language and body language.

The present invention discloses a system for capturing user language and body language actions exhibited as they consume data, then correlating the actions exhibited by the user with the consumed data, thereby deducing a reaction of the user caused by the data.

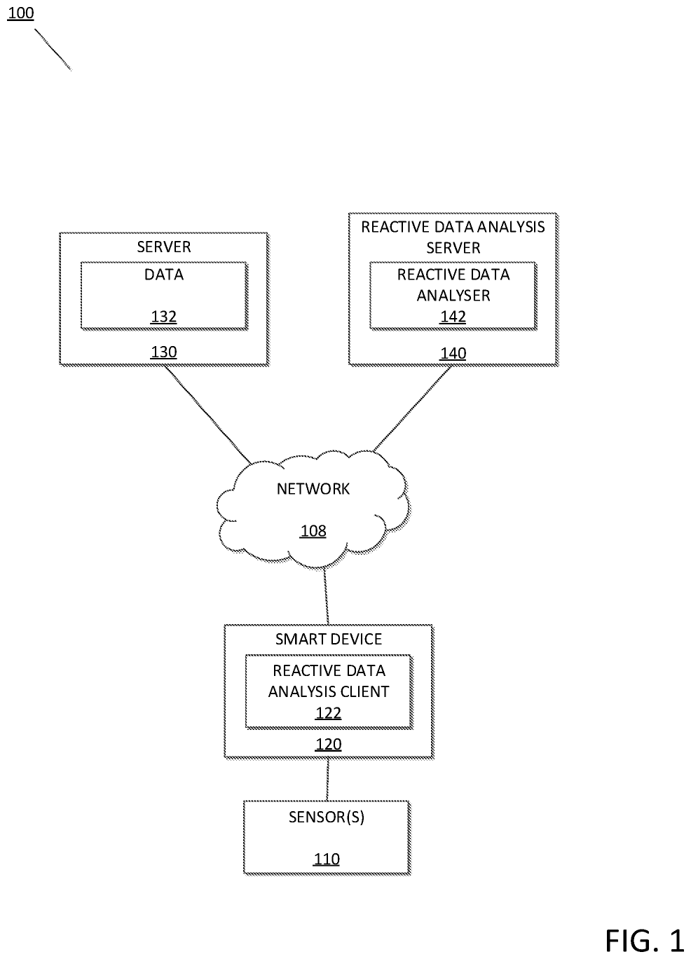

FIG. 1 depicts the reactive data analysis system 100, in accordance with exemplary embodiments. According to the exemplary embodiments, the reactive data analysis system 100 may include sensor(s) 110, a smart device 120, a data server 130, and a reactive data analysis server 140, which all may be interconnected via a network 108. While programming and data of the exemplary embodiments may be stored and accessed remotely across several servers via the network 108, programming and data of the exemplary embodiments may alternatively or additionally be stored locally on as few as one physical computing device or amongst other computing devices than those depicted. The operations of the reactive data analysis system 100 are described in greater detail herein.

In the exemplary embodiments, the network 108 may be a communication channel capable of transferring data between connected devices. In the exemplary embodiments, the network 108 may be the Internet, representing a worldwide collection of networks and gateways to support communications between devices connected to the Internet. Moreover, the network 108 may utilize various types of connections such as wired, wireless, fiber optic, etc. which may be implemented as an intranet network, a local area network (LAN), a wide area network (WAN), or a combination thereof. In further embodiments, the network 108 may be a Bluetooth network, a Wi-Fi network, or a combination thereof. The network 108 may operate in frequencies including 2.4 gHz and 5 gHz internet, near-field communication, Z-Wave, Zigbee, etc. In yet further embodiments, the network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices.

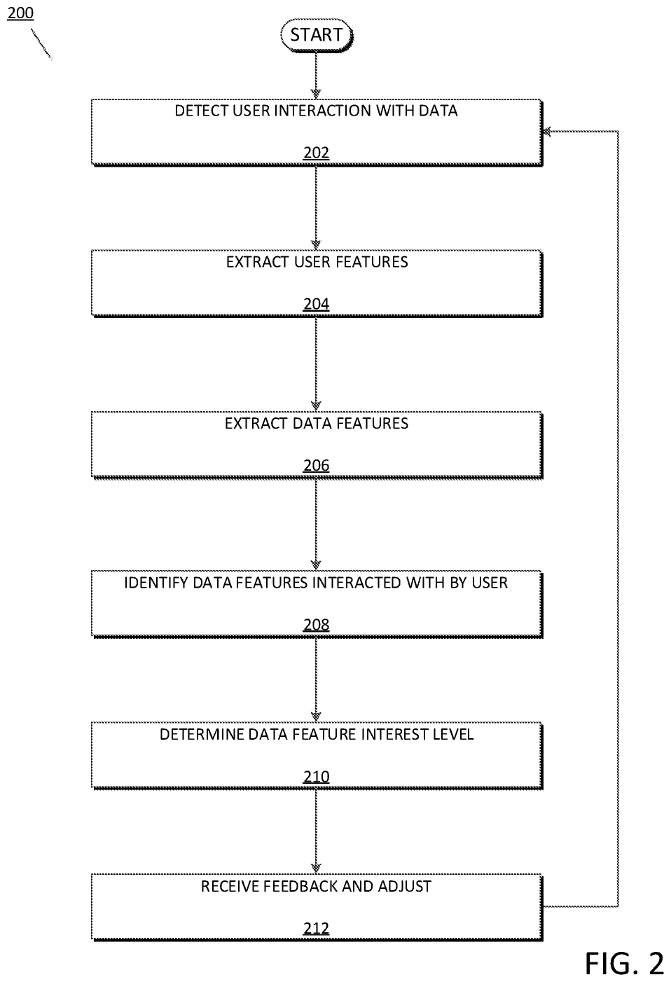

In exemplary embodiments, the sensor(s) 110 may be one or more devices capable of collecting data. In particular, the sensor(s) 110 may be configured to collect data with respect to a user, and may be a camera, video camera, microphone, accelerometer, gyroscope, heart rate monitor, light sensor, temperature sensor, vibration sensor, etc., as well as special purpose or medical devices. Accordingly, the sensor(s) 110 may be integrated into smart devices such as smart phones (the smart device 120), smart watches, smart glasses, and the like. While FIG. 2 illustrates the sensor(s) 110 as being in communication with the smart device 120, in other embodiments the sensor(s) 110 may communicate directly with the network 108. Moreover, while FIG. 2 illustrates the sensor(s) 110 as a separate component from the smart device 120, in other embodiments the sensor(s) 110 may be integrated entirely into the smart device 120. The sensor(s) 110 are described in greater detail with respect to FIG. 2-5.

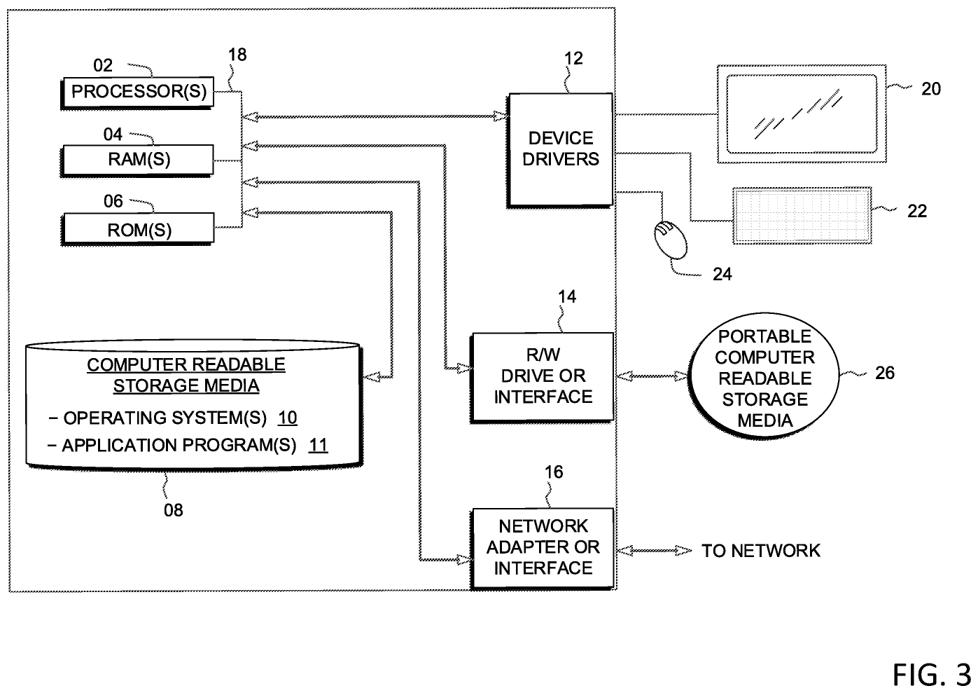

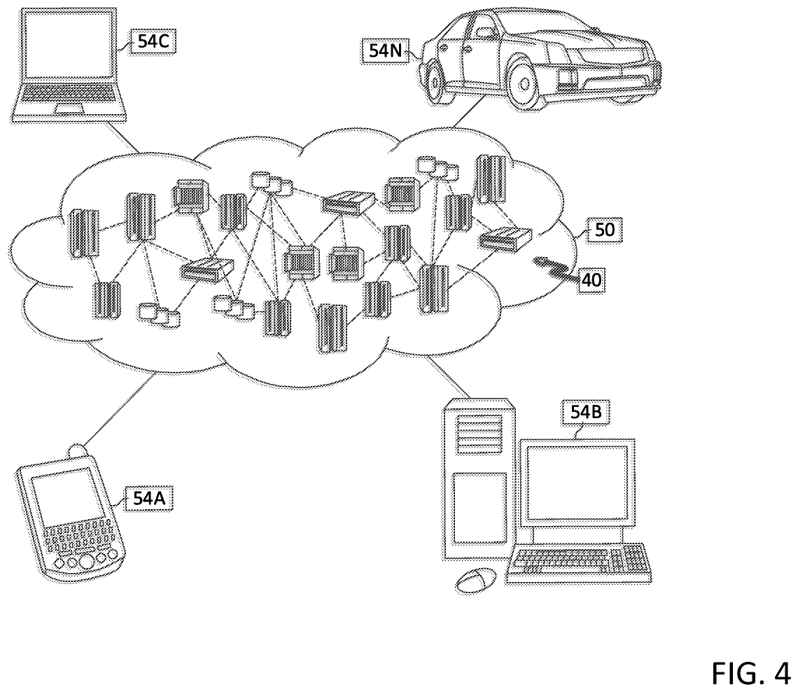

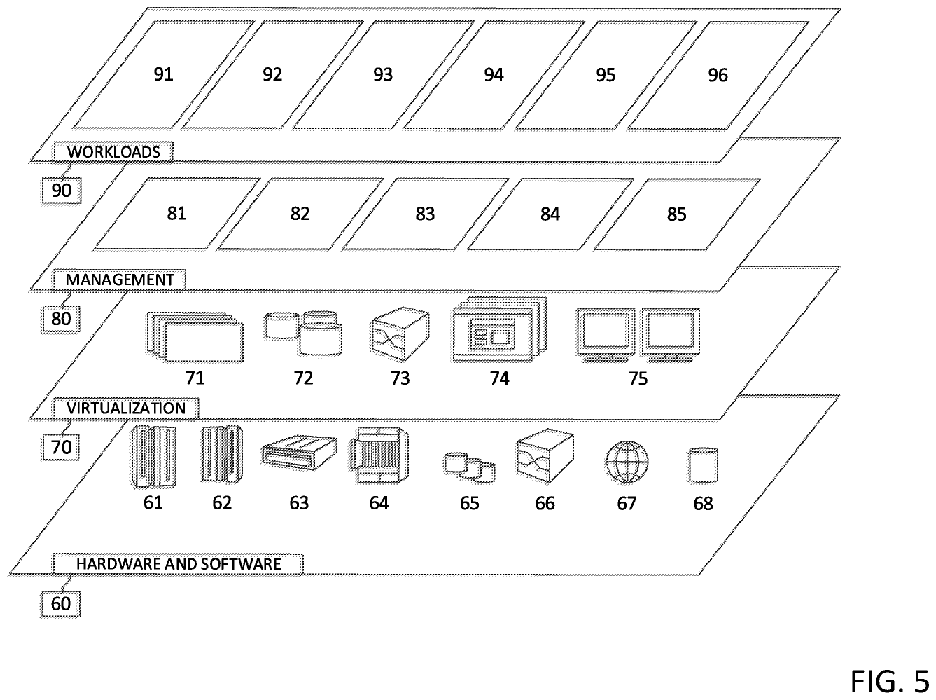

In exemplary embodiments, the smart device 120 includes a reactive data analysis client 122, and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of sending an receiving data to and from other computing devices. While the smart device 120 is shown as a single device, in other embodiments, the smart device 120 may be comprised of a cluster or plurality of computing devices, in a modular manner, etc., working together or working independently. The smart device 120 is described in greater detail as a hardware implementation with reference to FIG. 3, as part of a cloud implementation with reference to FIG. 4, and/or as utilizing functional abstraction layers for processing with reference to FIG. 5.

The reactive data analysis client 122 may act as a client in a client-server relationship, and may be a software and/or hardware application capable of communicating with and providing a user interface for a user to interact with a server and other computing devices via the network 108. Moreover, in the example embodiment, the reactive data analysis client 122 may be capable of transferring data from the smart device 120 and/or the sensor(s) 110 to and from other devices via the network 108. In embodiments, the reactive data analysis client 122 may be capable of detecting, monitoring, and/or intercepting data retrieved on the smart device 120 and/or the sensor(s) 110 via, for example, the network 108. The reactive data analysis client 122 is described in greater detail with respect to FIG. 2-5.

In exemplary embodiments, the data server 130 includes data 132, and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of sending and receiving data to and from other computing devices. While the data server 130 is shown as a single device, in other embodiments, the data server 130 may be comprised of a cluster or plurality of computing devices, in a modular manner, etc., working together or working independently. The data server 130 is described in greater detail as a hardware implementation with reference to FIG. 3, as part of a cloud implementation with reference to FIG. 4, and/or as utilizing functional abstraction layers for processing with reference to FIG. 5.

The data 132 may be one or more databases detailing various structured and unstructured data. For example, the data may be one or more databases, websites, forums, postings (e.g., job or team), and the like. In some embodiments, the data 132 may correspond to a program application that be accessed via the smart device 120. Overall, the data 132 may be any information accessed via the network 108.

In exemplary embodiments, the reactive data analysis server 140 includes a reactive data analyser 142, and may act a server in a server-client relationship with the reactive data analysis client 122. The reactive data analysis server 140 may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of sending and receiving data to and from other computing devices. While the reactive data analysis server 140 is shown as a single device, in other embodiments, the reactive data analysis server 140 may be comprised of a cluster or plurality of computing devices, in a modular manner, etc., working together or working independently. The reactive data analysis server 140 is described in greater detail as a hardware implementation with reference to FIG. 3, as part of a cloud implementation with reference to FIG. 4, and/or as utilizing functional abstraction layers for processing with reference to FIG. 5.

The reactive data analyser 142 may be a software and/or hardware program that may detect user interaction with data and extract user features. In addition, the reactive data analyser 142 may extract data features, as well as identify data features interacted with by the user. The reactive data analyser 142 may further determine a user interest level in the data features interacted with by the user, and receive feedback in order to adjust models. The reactive data analyser 142 is described in greater detail with reference to FIG. 2-5.

FIG. 2 depicts an exemplary flowchart 200 illustrating the operations of the reactive data analyser 142 of the reactive data analysis system 100, in accordance with the exemplary embodiments. In general, the reactive data analyser 142 may be configured to identify data features interacted with by a user and determine an interest level in the data features based on user reactions.

The reactive data analyser 142 may detect user interaction (step 202). In embodiments, the reactive data analyser 142 may detect user interaction based via communication with the reactive data analysis client 122 and, more specifically, by detecting when a user interacts with the smart device 120. For example, interaction with the smart device 120 may include the user unlocking, selecting, typing, highlighting, scrolling, opening program applications, etc. on the smart device 120. In addition, the reactive data analyser 142 may further detect user interaction via the sensor(s) 110, for example via a camera to detect user eye contact, or light sensor to detect forward facing movement/activity. In addition, the reactive data analyser 142 may further detect user interaction via an accelerometer, gyroscope, etc. to determine the smart device 120 is being held or is facing a user. In embodiments implementing devices that enable sleep after a defined amount of inactive time, such as smart phones/tablets/computers, the reactive data analyser 142 may be configured to detect user interaction any time the device or a corresponding display is enabled/on. In general, the reactive data analyser 142 may detect user interaction via any means available.

In order to better illustrate the operations of the reactive data analyser 142, reference is now made to an illustrative example wherein the reactive data analyser 142 detects user interaction based on a user unlocking their smart phone.

The reactive data analyser 142 may extract one or more user features (step 204). In embodiments, the reactive data analyser 142 may first extract user features from a corresponding user profile, such as one associated with a user account or the device. In such embodiments, the reactive data analyser 142 may extract user features from a user profile via, for example, login via user credentials (username and pass), internet protocol (IP) address, media access control (MAC) address, etc. The extracted applicant features may include general demographic information such as user name, address, gender, age, etc., as well as other user features such as interests, hobbies, network connections, associated groups, profession, education/education level, experience, qualifications, certifications, skills, current position/employment, position/employment history, current/expected compensation, etc.

In addition, the reactive data analyser 142 may further extract user features via the smart device 120 and/or the sensor(s) 110. For example, the reactive data analyser 142 may extract user features relating to applicant eye gaze direction relative to a display screen via a smart phone or laptop camera in conjunction with eye tracking technology. Similarly, the reactive data analyser 142 may extract user features relating to concentration level via, for example, analysis of pupil dilation, heart rate, and/or other information retrieved from a smart device such as a watch or phone. In embodiments, the reactive data analyser 142 may further extract user features relating to facial expressions via the sensor(s) 110, including smiles, frowns, squints, shrugs, etc. Based on at least the extracted facial expression(s), the reactive data analyser 142 may further deduce and extract one or more emotions of the user, including happiness, sadness, excitement, disappointment, etc. Moreover, the reactive data analyser 142 may further implement lip reading technology and/or audio transcription/speech-to-text technologies in conjunction with natural language processing techniques to extract natural language and topics from recited user natural language. Overall, the reactive data analyser 142 may be configured to extract any feature relevant to the user via the sensor(s) 110 and/or smart device 120.

When applicable, the reactive data analyser 142 may further associate a time stamp with the extracted user features indicative of a time at which the user features were extracted, such as a time during which the user gazed at a particular area of a display, a timeframe in which the user exhibited a high concentration level on an area of the display, a time at which the user spoke or recited text of the data to themselves, etc. By doing so, the reactive data analyser 142 may be capable of generating a chronological timeline of the one or more user features, and further capable of matching the user features to the displayed data based on the time stamps (described in greater detail forthcoming).

With reference again to the illustrative example introduced above, the reactive data analyser 142 extracts user features that include demographic information of a male aged 32. In addition, the reactive data analyser 142 extracts user features that include eye gaze directions, eye gaze durations, concertation levels, recited natural language, and facial expressions.

The reactive data analyser 142 may extract data features from the data (step 206). In embodiments, the data features may relate to the data viewed by the user, such as entities, topics, subtopics, values, etc. that may be detailed by text, photos, videos, audio, etc. of the data. For example, the reactive data analyser 142 may extract data features from the contents of a news article/feed, image, video, audio, game, job posting, athletic team posting, etc. The reactive data analyser 142 may extract such data features via reference to the data, for example corresponding webpage and application elements (titles, headers, bodies, etc.), source code, metadata, tags/hashtags, topics, text, etc. The reactive data analyser 142 may extract the data features relating to natural language by applying topic modelling, natural language processing, etc., to structured and unstructured text detailed by the data. In embodiments, the reactive data analyser 142 may further spatially and temporally map the locations of the one or more data features with respect to a screen size of the smart device 120, scroll positions within a webpage or an application, zoom level, etc. For example, the reactive data analyser 142 may map each extracted data feature to locations within a display of the user based on a timestamp at which the data features was displayed. Thus, the reactive data analyser 142 constructs a representation of the locations at which the data features were displayed on the user device as well as a duration during which the data features were displayed at those locations.

With reference to the formerly introduced example, the reactive data analyser 142 extracts data features from the data that the 32 year old male interacted with that include a sports score, an invitation to a party, a chat dialogue, a news headline, an email bill, a work email, and an advertisement.

The reactive data analyser 142 may identify data features interacted with by the user (step 208). Of the extracted data features, the reactive data analyser 142 may first identify data features interacted with by the user based on data features selected, highlighted, scrolled over, etc. by the user. In addition, the reactive data analyser 142 may identify data features interacted with by the user based on the user viewing the data feature, which may be deduced based on temporally correlating the user features with the mapping of the data features relative to the display of the user. More specifically, the reactive data analyser 142 may match the user eye gaze direction at recorded timestamps to the data features displayed in those directions at/during/around those timestamps, thereby identifying the data features viewed by the user. In some embodiments, the reactive data analyser 142 may further identify data features viewed by the user based on exhibited user natural language, for example natural language mouthed or recited by the user that matches a text, topic, etc. of a displayed data feature. In general, the reactive data analyser 142 may identify any number of data features interacted with by the user, and may do so in various techniques.

Returning to the previously introduced example, the reactive data analyser 142 determines that the 32 year old male responded in the chat dialogue, RSVP′d to the invitation to a party, and opened the email bill. In addition, the reactive data analyser 142 determines that the user interacted with the sports score based on a time and direction of the user eye gaze and the time and direction at which the sports score was displayed. Lastly, the reactive data analyser 142 determines that the user interacted with the news headline based on the user reciting the headline to themselves. Accordingly, the reactive data analyser 142 determines that the user did not interact with the work email and advertisement.

The reactive data analyser 142 may determine interest levels for the data features interacted with by the user (step 210). In embodiments, the reactive data analyser 142 may deduce user interest levels in the data feature based on user features exhibited at the time of interaction, such as eye gaze duration, concentration level, recited natural language, pupil dilation, heart rate, facial expression (smile, frown, squint, yawn, eye roll, shrug, etc.), deduced emotion (happiness, sadness, confusion, anger, etc.), etc., all of which may be indicative of high or low interest in the subject data feature. For example, long eye gaze duration, high concentration level, pupil dilation, high heart rate, smiling facial expression, and happy emotions may be associated with high interest levels while, conversely, short eye gaze duration, low concentration level, lack of pupil dilation, low heart rate, frowning facial expression, and sad or angry emotions may be associated with low interest level. The reactive data analyser 142 may further determine interest level based on user natural language and, for example, determine interest level based on the user mouthing or reciting text, topics, etc. detailed by a data feature. Based on the one or more user features exhibited at/around a time at which the user interacted with the data feature, the reactive data analyser 142 may deduce a corresponding user interest level. In embodiments, the reactive data analyser 142 may identify interest based on any one or more of the user features, and in some embodiments may weight the interest level associated with the one or more user features based on the feature, a duration of the feature, etc. in a model that outputs an overall interest level for each of the data features viewed by the user.

With reference again to the example above, the reactive data analyser 142 may determine a high interest level in the chat dialogue based on the user laughing during interaction. In addition, the reactive data analyser 142 may determine a medium interest level in the invitation to the party based on the user rolling their eyes while RSVP'ing. Similarly, the reactive data analyser 142 may determine a low interest in the email bill based on the user expressing anger and frowning during opening. In addition, the reactive data analyser 142 may determine a high interest level in the sports score based on the user cheering at the time when the user viewed the sports score. Lastly, the reactive data analyser 142 determines a medium level of interest in the news headline based on the user shrugging while reciting the headline to themselves.

The reactive data analyser 142 may further determine interest levels for data features interacted with amongst groups of user, such as peers, colleagues, applicants, etc., in order to identify trends in user interests (step 210 continued). In embodiments, the reactive data analyser 142 may consider excess of an absolute or relative threshold number of users/user interest level to a particular data feature as a trend. Such trends may be indicative changes in the landscape with respect to those users, the field of the users, etc., as well as the data features themselves. Moreover, by identifying groups of users and corresponding interest levels, the reactive data analyser 142 may be capable of categorizing, ranking, etc. the users and data features.

Returning to the previously introduced example, the reactive data analyser 142 may categorize the user based on demographics, such as age and gender, as well as data features of interest, such as sports related data features.

The reactive data analyser 142 may receive feedback and adjust models (step 212). In embodiments, the reactive data analyser 142 may receive feedback in the form of user input, continued interaction with a data feature, etc. The reactive data analyser 142 may then use the received feedback to adjust the weights and the manner in which the data features interacted with by the user and corresponding interest levels are identified. For example, in embodiments implementing a model, the reactive data analyser 142 may adjust weights corresponding to the user features relied on in identifying interest level.

Concluding the example above, the reactive data analyser 142 may detect that the user subsequently selected the news headline that he recited, and therefore increases a weight associated with the user feature of reciting text or topic of a data feature.

FIG. 3 depicts a block diagram of devices within the reactive data analysis system 100 of FIG. 1, in accordance with the exemplary embodiments. It should be appreciated that FIG. 3 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 40 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and interest processing 96.

The exemplary embodiments may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for analysing reactive user data, the method comprising:
detecting interaction with data by a user;
extracting one or more user features from the user;
extracting one or more data features from the data;
identifying one or more data features interacted with by the user of the one or more data features;
matching the one or more user features with the one or more data features interacted with by the user; and
determining an interest level in the one or more data features interacted with by the user based on the matched one or more user features.

2. The computer-implemented method of claim 1, wherein the one or more user features include eye gaze direction, eye gaze duration, concentration level, pupil dilation, heart rate, facial expression, emotion, and natural language.

3. The computer-implemented method of claim 2, wherein identifying the one or more data features interacted with by the user of the one or more data features further comprises:
identifying at least one data feature of the one or more data features displayed in the eye gaze direction of the user during a time at which the user exhibited the eye gaze direction.

4. The computer-implemented method of claim 1, wherein matching the one or more user features with the one or more data features interacted with by the user further comprises:
identifying a timestamp associated with the one or more user features; and
identifying the one or more data features interacted with by the user that were interacted with within a threshold time of the timestamp associated with the one or more user features.

5. The computer-implemented method of claim 4, wherein determining an interest level in the one or more data features interacted with by the user based on the matched one or more user features further comprises:
determining an interest level associated with the one or more user features; and
correlating the interest level associated with the one or more user features with the one or more data features interacted with by the user that were interacted with within the threshold time of the timestamp associated with the one or more user features.

6. The computer-implemented method of claim 1, wherein determining an interest level in the one or more data features interacted with by the user based on an interest level associated with the matched one or more user features is based on a model.

7. The computer-implemented method of claim 6, further comprising:
receiving feedback; and
updating the model.

8. A computer program product for analysing reactive user data, the computer program product comprising:
one or more non-transitory computer-readable storage media and program instructions stored on the one or more computer-readable storage media, the program instructions comprising a method for:
detecting interaction with data by a user;
extracting one or more user features from the user;
extracting one or more data features from the data;
identifying one or more data features interacted with by the user of the one or more data features;
matching the one or more user features with the one or more data features interacted with by the user; and
determining an interest level in the one or more data features interacted with by the user based on the matched one or more user features.

9. The computer program product of claim 8, wherein the one or more user features include eye gaze direction, eye gaze duration, concentration level, pupil dilation, heart rate, facial expression, emotion, and natural language.

10. The computer program product of claim 9, wherein identifying the one or more data features interacted with by the user of the one or more data features further comprises:
identifying at least one data feature of the one or more data features displayed in the eye gaze direction of the user during a time at which the user exhibited the eye gaze direction.

11. The computer program product of claim 8, wherein matching the one or more user features with the one or more data features interacted with by the user further comprises:
identifying a timestamp associated with the one or more user features; and
identifying the one or more data features interacted with by the user that were interacted with within a threshold time of the timestamp associated with the one or more user features.

12. The computer program product of claim 11, wherein determining an interest level in the one or more data features interacted with by the user based on the matched one or more user features further comprises:
determining an interest level associated with the one or more user features; and
correlating the interest level associated with the one or more user features with the one or more data features interacted with by the user that were interacted with within the threshold time of the timestamp associated with the one or more user features.

13. The computer program product of claim 8, wherein determining an interest level in the one or more data features interacted with by the user based on an interest level associated with the matched one or more user features is based on a model.

14. The computer program product of claim 13, further comprising:
receiving feedback; and
updating the model.

15. A computer system for analysing reactive user data, the computer system comprising:
one or more computer processors, one or more computer-readable storage media, and program instructions stored on one or more of the computer-readable storage media for execution by at least one of the one or more processors, the program instructions comprising:
detecting interaction with data by a user;
extracting one or more user features from the user;
extracting one or more data features from the data;
identifying one or more data features interacted with by the user of the one or more data features;
matching the one or more user features with the one or more data features interacted with by the user; and
determining an interest level in the one or more data features interacted with by the user based on the matched one or more user features.

16. The computer system of claim 15, wherein the one or more user features include eye gaze direction, eye gaze duration, concentration level, pupil dilation, heart rate, facial expression, emotion, and natural language.

17. The computer system of claim 16, wherein identifying the one or more data features interacted with by the user of the one or more data features further comprises:
identifying at least one data feature of the one or more data features displayed in the eye gaze direction of the user during a time at which the user exhibited the eye gaze direction.

18. The computer system of claim 15, wherein matching the one or more user features with the one or more data features interacted with by the user further comprises:
identifying a timestamp associated with the one or more user features; and
identifying the one or more data features interacted with by the user that were interacted with within a threshold time of the timestamp associated with the one or more user features.

19. The computer system of claim 18, wherein determining an interest level in the one or more data features interacted with by the user based on the matched one or more user features further comprises:
determining an interest level associated with the one or more user features; and
correlating the interest level associated with the one or more user features with the one or more data features interacted with by the user that were interacted with within the threshold time of the timestamp associated with the one or more user features.

20. The computer system of claim 1, wherein determining an interest level in the one or more data features interacted with by the user based on an interest level associated with the matched one or more user features is based on a model, and further comprising:
receiving feedback; and
updating the model.
